(19) United States
(12) Patent Application Publication
(10) Pub. No.: US 2008/0271517 A1
(43) Pub. Date: Nov. 6, 2008

(54) Non-Invasive Gas Monitoring for Manufactured Multiple Paned Glass Units

(76) Inventors: Adrian Guckian, Co. Meath (IE); Maja Dyson, Co. Meath (IE)

Correspondence Address: BROWN RUDNICK LLP, ONE FINANCIAL CENTER, BOSTON, MA, 02111, US

(21) Appl. No.: 12/097,111

(22) PCT Filed: Dec. 12, 2006
(86) PCT No.: PCT/IB06/04203

§ 371 Date: Jul. 8, 2008

Related U.S. Application Data
(60) Provisional application No. 60/749,415, filed on Dec. 12, 2005.

(51) Int. Cl. G01N 7/00

(52) U.S. Cl. 73/19.01

(57) ABSTRACT

A system for determining gas content in an enclosed atmosphere (6) is provided. The system for determining gas content includes a window unit (2, 4) having an enclosed atmosphere and an oxygen sensing material (8) disposed in the enclosed atmosphere. The oxygen sensing material detects a level of oxygen in the enclosed atmosphere. A non-invasive sensor (10) reads the oxygen sensitive material to determine the level of gases within the enclosed atmosphere.

### BACKGROUND

1. Technical Field

The present disclosure generally relates to non-invasive gas monitoring for manufactured multiple paned glass units and, more particularly, to non-invasive gas monitoring and gas fill analyzer systems for manufactured multiple paned insulated glass units such as windows, doors and related products.

2. Description of the Related Art

The insulating benefits of filling the sealed interpane space between double and tripled paned windows, doors, and other related products with an inert gas such as argon or krypton have long been known (see, for example, British Fenestration Rating Council at www.bfrc.org). Filling gases with low thermal conductivity, e.g., argon, krypton and xenon are used for a considerable reduction of heat transfer in window glazing units. The thermal insulation performance of the glazing units depends acutely on the type and percentage fill of gas in the interpane spacing. The insulating gases used in the interpane space in insulated glass units (IGUs) are necessarily invisible to the eye.

There is a long standing problem of calculating the amount of such gases present inside a sealed IGU post-manufacture. This problem is faced both at the site of manufacture and at the site where the window is installed. The very act of measuring typically involves breaking the IGU seal and thus compromises the integrity and future thermal performance of the IGU. The manufacturer has typically had only invasive methods of measuring the quality of the IGU gas fill and this by its nature could only be a statistical sample method. In-situ installed gas filled IGUs are rarely tested for inert gas fill following installation.

The problem was to calculate without breaking the seal, i.e., non-invasively, the level of the Insulating Gas Fill (IGF) inside a sealed double or triple paned IGU on 100% of the production from an IGU manufacturing plant. In addition to calculate the level of IGF on installed IGUs during the working life of the window and to provide the end customer with tangible evidence, in the form of the sensor, of the continuing presence of the high technology gas fill monitoring solution.

An IGF is placed inside the sealed IGU to improve the insulating quality of the IGU. The problem is that the manufacturing process can have errors which lead to a reduced level of insulating gas at the manufacturing plant. In addition, because of faulty seals on the IGU, the IGF can leak ever time thereby reducing the overall insulating effect of the window unit. There has been no effective, non-invasive, method for the checking of the quality of the IGF on an individual product level basis across 100% of the production at the point of manufacture and no effective method for checking the IGF on installed IGUs during their productive life. An important aspect of the solution is that the sensors are mass produced in large batches (1 million plus) so that they are both cost effective for large scale adoption and useable in a high volume production line environment. The sensors need to be manufactured in a manner which yields identical properties across each batch.

In general sealed IGUs are tested invasively or are destructively tested to allow for the analysis of the gas composition. Invasive testing involves the insertion of a probe through the side of the IGU which allows an amount of the gas within the IGU to be extracted and tested. Destructive testing involves the destruction of the unit and the again the extraction of a sample of the gases inside the IGU for testing and analyses. Both of these methods have obvious drawbacks by effectively destroying the product tested and do not allow a 100% testing quality control approach.

Sealed IGUs are also tested spectroscopically (See, for example, U.S. Pat. No. 6,795,178). The approach causes a high voltage spark to ignite inside the IGU without breaking the IGU seal. This high voltage spark causes the argon atom to emit light to a spectrometer, which measures the light. The information is then interpreted and the percentage argon fill is calculated. This solution is unique to a specific inert gas and does not read multiple insulating gases. There is another solution where the IGF is read non-invasively though the glass in U.S. Pat. No. 5,650,845. However, the time to take an individual reading is greater than 15 seconds which renders the solution unusable in a production line environment.

Additionally colorimetric oxygen sensors have been tried in a similar fashion but their accuracy is highly subjective and not practical over the wide range of gas fills.

Any solution which invasively tests has obvious drawbacks. Any invasive solution has the same results as destructive testing in that the product is rendered useless by the act of testing. The spectroscopic solution is an alternative non-invasive approach but is not supportive of a 100% testing online solution in a high volume production line environment as it can require a number of readings on the same IGU which are then averaged to yield the overall result. The time required to execute this process again renders this approach unfriendly to a high volume production line environment. In addition the required high voltage can damage sensitive coatings on the glass panes with the high voltage spark it generates. This approach also has problems with the repeatability and accuracy of its results and cannot read through certain glass types such as frosted. The spectroscopic approach also has the drawback of not requiring a sensor which accompanies the IGU throughout its life. Colorimetric oxygen sensors have inherent drawbacks in that the colour change and thus accuracy is subjective.

Thus, an object of the present disclosure is to provide an improved non-invasive gas monitoring and gas fill analyzer system for calculating the level of the Insulating Gas Fill (IGF) inside a sealed double or triple paned IGU on 100% of the production from an IGU manufacturing plant to assist in quality control processes.

It is another object of the present disclosure to provide an improved non-invasive gas monitoring and gas fill analyzer system that is able to calculate the level of IGF on installed IGUs during the working life of the window and to provide the end customer with tangible evidence, in the form of the sensor, of the continuing presence of the high technology gas fill monitoring solution.

It is yet another object of the present disclosure to provide an improved non-invasive method for monitoring the level of IGF inside a paned window during production and during the working life of the window.

Other objects and advantages of the present invention shall become apparent from the accompanying description and drawings.

### SUMMARY

Accordingly, the system of the present disclosure provides for an improved non-invasive gas monitoring and gas fill analyzer system for use in determining the level of IGF during manufacture and during the working life of the window. The non-invasive gas monitoring and gas fill analyzer system includes a window unit having an enclosed atmosphere and oxygen sensing material disposed in the enclosed atmosphere. The oxygen sensing material detects a level of oxygen in the enclosed atmosphere and may be placed on any surface of the enclosed atmosphere. The oxygen sensing material may be an oxygen sensitive ink or dye, and in particular, a ruthenium complex.

A method of determining the gas content of an enclosed atmosphere in provided. The method includes providing a window unit having an enclosed atmosphere and an oxygen sensing material disposed in the enclosed atmosphere. The method also includes providing a sensor that non-invasively reads the oxygen sensing material to analyze oxygen content and determine the gas content of the enclosed atmosphere.

Additionally, the method and system of the present disclosure provides for ease and speed of use in addition to a low cost per unit, which allows 100% inline quality control testing on every IGU produced at the factory and to monitor the effectiveness of the IGF over time in the installed IGU.

### BRIEF DESCRIPTION OF THE DRAWINGS

The objects and features of the present disclosure are set forth with particularity in the appended claims. The present disclosure, as to its organization and manner of operation, together with further objectives and advantages may be understood by reference to the following description, taken in connection with the accompanying drawings, in which:

FIG. 1 is a cross-sectional view of a non-invasive gas monitoring and gas fill analyzer system in accordance with one embodiment of the present disclosure; and

FIG. 2 is a cross-sectional view of a non-invasive gas monitoring and gas fill analyzer system in accordance with another embodiment of the present disclosure.

### DETAILED DESCRIPTION OF EXEMPLARY EMBODIMENTS

The exemplary embodiments of the non-invasive gas monitoring and gas fill analyzer systems disclosed are discussed in terms of gas monitoring and gas fill analyzers for use with inert gas filled windows including, for example, double and tripled paned windows filled with inert gas such as argon or krypton. The presently disclosed non-invasive gas monitoring and gas fill analyzer systems are contemplated for use as an integral part of the manufacturing process as well as an important feature of the window for further monitoring of IGF throughout the life of the window. It is contemplated that the gas monitoring and gas fill analyzers of the present disclosure may be employed with, for example, double and triple paned windows or other devices which employ an enclosed atmosphere. Other such devices can include, but are not limited to, doors and cases for the protection of documents or other artifacts from the outside atmosphere.

The following discussion includes a description of the non-invasive gas monitoring and gas fill analyzer systems according to the present disclosure. Reference will now be made in detail to the exemplary embodiments of the disclosure, which are illustrated in the accompanying Figures.

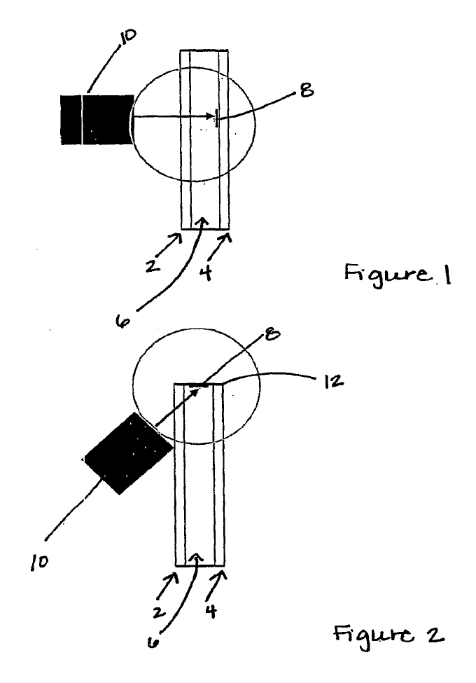

Turning now to the Figures, wherein like components are designated by like reference numerals. Referring to FIG. 1, there is illustrated a non-invasive gas monitoring and gas fill analyzer system, in accordance with the present disclosure. Window panes are shown generally as 2 and 4. An interpane space 6 is disposed between panes 2 and 4. Interpane space 6 is filled with an inert gas at the time of manufacturing. This inert gas can include, but is not limited to, argon or krypton. Interpane 6 is sealed which creates an enclosed atmosphere filled with gas. In this embodiment, oxygen sensing material 8 is located on pane 4 in interpane space 6. Oxygen sensing material 8 can be a multi-layered self adhesive label and can be manufactured to any shape and size. Alternatively, oxygen sensing material 8 can be can be printed, sprayed or otherwise directly applied to any surface in the enclosed atmosphere of interpane space 6 in the form of a dye or an ink.

In an embodiment in accordance with the present disclosure, the oxygen sensing material 8 is ink; however, any known substrate can also be used including those substrates that can otherwise absorb or be adhered to by an ink material. Ink can include a fluid or viscous substance used for writing, printing or defining any type of indicia on or relative to an object.

A sensor 10, which is located outside of the panes 2 and 4, can read oxygen sensing material 8. This allows for sensor 10 to monitor oxygen levels in interpane space 6 during manufacturing and during the life of the window without having to break the IGU seal or damaging the sensitive glass coatings.

In an exemplary embodiment of the present disclosure, oxygen sensing material 8 is a ruthenium complex which emits light when excited by an optical head. This sensing material can be provided in the form of SensiSpots™. The emitted light is extremely sensitive to oxygen, and detection of this light by the optical head allows the concentration of oxygen inside the enclosed atmosphere of interpane space 6 to be accurately determined in a non-invasive manner.

In this embodiment, the technology is based on three components. The components include, fluorescent chemical complexes, sol-gel based oxygen sensing materials, and measuring instrumentation and software.

In this embodiment, fluorescence quenching is the mechanism that takes place. This means that the oxygen molecules absorb the energy that would otherwise be emitted in the form of fluorescent light, and so more fluorescence takes place in the absence of oxygen than in its presence. Because the oxygen sensing material 8 is interrogated by light, the measurement can be non-invasive, i.e. oxygen sensing material 8 on the inside of a system can be measured from the outside (provided the barrier is transparent to light in the blue and orange regions of the spectrum).

The substance in which the fluorescent complexes are entrapped can be implemented to increase the oxygen sensing material's performance. This substance can be sol-gel. A sol-gel is a robust, nano-porous glass which provides the ability to entrap the ruthenium complex using low temperature technology. Sol-gel offers several advantages over polymers as an immobilization matrix including, but not limited to, superior mechanical strength, excellent optical transparency, printability, and the sol-gel does not swell as ambient humidity varies More fluorescence occurs in the absence of oxygen than in its presence. The level of oxygen can be determined extremely accurately by detecting changes in the fluorescence of the oxygen sensing material 8. The fluorescence from the illuminated SensiSpots™ is quenched by oxygen.

In an alternative embodiment as shown in FIG. 2, oxygen sensing material 8 is located on a spacer bar 12. Oxygen sensing material 8 can be applied to a variety of different areas within interpane space 8. This gives the manufacturer the flexibility to place oxygen sensing material 8 anywhere within interpane 6, provided it is exposed to the enclosed atmosphere, to determine the current level of IGF.

The level of the IGF whether argon or krypton, etc. can be determined by the calculation of the oxygen level inside the sealed IGU. The level of the IGF can then be calculated with an accuracy of better than 0.5% and in less than 0.5 seconds. The sensor has a multi-year re-useable readable lifetime within the IGU and can be interrogated both at the factory directly after manufacture and during the working life of the IGU following installation. This process of sensing and determining the gas content can be completely reversible and neither the oxygen sensing material 8 nor the oxygen is consumed in the measurement.

By way of a non-limiting example, the present disclosure can be used at a manufacturing facility. There are many different systems available for gas filling and sealing IGUs both on automated, semi-automated, and manual production lines. Neither the filling nor the sealing of IGUs is a perfect science and as the fill gases used are invisible, gas filled IGUs are tested post-production and typically tested on a sample basis only. This can result in one IGU tested per shift per day. A medium size automated IGU manufacturing line may produce in the range of 1,000 per 10 hour shift. The process and system of the present disclosure can allow 100% quality control testing as the oxygen or gas sensor can be applied by an automated label applicator in the production line and the IGF calculated immediately following gas fill by our reader also built into the production line. Those units that do not pass the gas fill test, e.g., where the argon fill is less than, for example, approximately 90%, are either resent for additional gas filling or are rejected. This system creates a way to ensure quality of the IGUs before they are available for sale. This can give consumers confidence that they will receive a top quality product without any defects of the IGF.

By way of an additional non-limiting example, the present disclosure can be used at the place of installation. When the IGU has passed the initial gas fill testing, has left the factory and has been installed in, for example, a house, the thermal performance of the window will strongly depend on the ability of the seal to retain the gas fill over time. The sensor will continue to offer the opportunity of accurately and non-invasively calculating the gas fill. When the gas fill falls below a certain level, which may be guaranteed by the manufacturer, the IGU can then be replaced. The replacement cost of the IGU is a fraction of the cost of the replacement of the window. Consumers will be encouraged that quality will be guaranteed throughout the life of the window.

In an alternate embodiment, a business and process method of marketing and selling IGUs is disclosed. Such process includes the final market products of doors & windows, which incorporate the IGUs, to the public and/or distributors and/or any intermediate entity and using either (i) the built-in gas fill analyzing abilities, or (ii) the ability to analyze the gas fill of the product to enhance the attractiveness of the products.

The benefits from such a marketing and selling approach can include, for the customer, enhanced product quality and superiority, enhanced confidence in product quality and superiority, supporting the actuality and image of long term reliable performance, and justification of higher price. Benefits for the salesman can include being able to differentiate themselves from the competition by offering a superior product, allowing claims of superiority to be validated or proven by the monitoring system, and justification of higher price. Benefits for the distributor or retailer can include allowing the channel partner to visit the customer on a continuing basis to prove the continued performance of the product, affording opportunities for additional sales, and justification of a higher price.

Such a system as described herein distinguishes itself from known prior art competition by having a system that allows manufactures to prove the integrity and accuracy of the manufacturing process. The system allows its manufacturers, retailers, and distributors to demonstrate that the products have been correctly, consistently, and accurately manufactured in conformity with both manufacturing and required performance standards. This system incorporates an environmentally friendly adoption of cutting edge technology.

The process of marketing and selling IGUs allows the a marketing or sales person of the gas fill analyzer according to the present disclosure to provide a guarantee of (a) gas fill integrity on delivery from the factory quality control, and (b) continued monitoring of the gas fill integrity.

The process broadens the selling approach based on the value adding gas analysis system, increases the perception of and/or the actual integrity of the product on delivery from the factory and on an ongoing basis post-installation of the window or door, increases the control of the manufacturer on his channel and supply chain partners by providing unique innovative and value adding elements to his product line, and increases the ability to interact with the customer for years into the future by the option to provide monitoring of the gas fill on an annual basis.

Each of the new customer interaction opportunities added by the need to monitor the IGU on site is an opportunity to sell further products and services and an opportunity to (i) justify the price increase of the product, (ii) establish the superior quality of the product above competitors, (iii) enhance ability to promote the product line based on gas sensing abilities, (iv) increase the confidence of the entire supply chain from the manufacturer through to the final customer, (x) distinguish and positively differentiate the IGU, windows, doors and other products from the competition, (xi) provide the allure of the high technology by providing proof of the invisible, (xii) and provide the ability to outsell similar standard windows, doors, and products that do not have such sensor technology.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A system for determining gas content comprising:
a window unit having an enclosed atmosphere and an oxygen sensing material disposed in said enclosed atmosphere, wherein said oxygen sensing material detects a level of oxygen in said enclosed atmosphere.

2. The system of claim 1 wherein said window unit is an enclosure with at least one translucent pane.

3. The system of claim 1 wherein said oxygen sensing material is applied to a surface of said enclosed atmosphere of said window unit in the form of a self adhesive label.

4. The system of claim 1 wherein said oxygen sensing material is directly applied to a surface of said enclosed atmosphere of said window unit.

5. The system of claim 1 wherein said oxygen sensing material is an ink or dye.

6. The system of claim 5 wherein said ink or dye can be applied directly to a surface of said window unit.

7. The system of claim 1 wherein said oxygen sensing material is a ruthenium complex.

8. The system of claim 1 further comprising an outside sensor that non-invasively reads said oxygen sensing material.

9. A method of determining the gas content of an enclosed atmosphere, the method comprising the steps of:
providing a window unit having an enclosed atmosphere and an oxygen sensing material disposed in said enclosed atmosphere, wherein said oxygen sensing material detects a level of oxygen in said enclosed atmosphere; and
providing a sensor outside of said window unit that non-invasively reads said oxygen sensing material to determine the gas content of said enclosed atmosphere.

10. The method of claim 9 wherein said window unit includes an enclosure with at least one translucent glass pane.

11. The method of claim 9 wherein the oxygen sensing material is applied directly to a surface of said enclosed atmosphere of said window unit in the form of a self adhesive label.

12. The method of claim 9 wherein the oxygen sensing material is ink or dye that is applied directly to a surface of said enclosed atmosphere of said window unit.

13. The method of claim 9 wherein the oxygen sensing material is a ruthenium complex.
